(19) United States
(12) Patent Application Publication
(10) Pub. No.: US 2014/0164179 A1
(43) Pub. Date: Jun. 12, 2014

(54) SYSTEM AND METHOD TO OPTIMIZE IN-STORE CUSTOMER EXPERIENCE

(71) Applicants: David Geisinger, Plymouth, MA (US); Bob Pond, Kings Park, NY (US); David Bovenschulte, River Vale, NJ (US); Dave Braunstein, Huntington, NY (US)

(72) Inventors: David Geisinger, Plymouth, MA (US); Bob Pond, Kings Park, NY (US); David Bovenschulte, River Vale, NJ (US); Dave Braunstein, Huntington, NY (US)

(21) Appl. No.: 14/100,897

(22) Filed: Dec. 9, 2013

Related U.S. Application Data
(60) Provisional application No. 61/734,611, filed on Dec. 7, 2012.

(51) Int. Cl. G06Q 30/06

(52) U.S. Cl. CPC G06Q 30/0613
USPC 705/26.41

(57) ABSTRACT

In various example embodiments, a system and method for providing optimized in-store customer experience is provided. Accordingly, a list of a plurality of customers from which a selection is made to initiate a customer session is provided to a mobile device of a user. A selection of a customer from the list of the plurality of customers is received. The selection initiates the customer session for the selected customer. Customer data including a customer profile of the customer that includes sizing and preference information of the selected customer is accessed. The mobile device presents a user interface for the customer session that presents products for customer review and access to the customer data.

### CROSS REFERENCE TO RELATED APPLICATION

The present application claims the priority benefit of U.S. Provisional Patent Application Ser. No. 61/734,611 filed on Dec. 7, 2012 and entitled “System and Method to Optimize In-Store Customer Experience,” which is incorporated herein by reference.

### FIELD

The present disclosure relates generally to the field of mobile device technology, and in a specific example embodiment, to optimizing in-store customer experience by leveraging mobile devices.

### BACKGROUND

Conventionally, retailers do not provide their associates with relevant information to allow the associates to influence the sales process as the associate is interacting with their customers. Additionally, customers are demanding more relevant, fast, and personalized in-store experiences.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to provide an optimized in-store customer experience.

FIG. 2 is a block diagram illustrating an example embodiment of an associate device.

FIG. 3 is a block diagram illustrating an example embodiment of a customer device.

FIG. 4 is a block diagram illustrating an example embodiment of a store management system.

FIG. 5A is an example screenshot of a user interface presenting an associate dashboard.

FIG. 5B is an example screenshot of the user interface presenting a customer contact list.

FIG. 5C is an example screenshot of the user interface presenting purchase history and profile information for a customer.

FIG. 5D is an example screenshot of the user interface presenting a spending summary for the customer.

FIG. 5E is an example screenshot of the user interface presenting a selling interface.

FIG. 5F is an example screenshot of the user interface presenting a product screen.

FIG. 5G is an example screenshot of the user interface presenting a user profile interface.

FIG. 5H is an example screenshot of the user interface presenting a notes screen.

FIG. 5I is an example screenshot of the user interface presenting a dressing room interface.

FIG. 6 is a flowchart of an example method for activating a customer session.

FIG. 7 is a flowchart of an example method for interacting with a virtual dressing MOM.

FIG. 8 is a flowchart of an example method for managing a customer hold process.

FIG. 9 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments provide systems and methods for optimizing in-store customer experience by leveraging mobile devices. Retailers can enable an in-store sales associate (hereinafter referred to as “associate”) to leverage vast amounts of omni-channel customer data (e.g., store data, social network/media data, gaming network data, kiosk data, online shopping data, mobile device data, offline transaction data, offline marketing data, email data, online transaction data, online marketing data, preference data, profile data) to provide a richer sales/customer experience and drive more loyalty and revenue. Accordingly, the associate is provided with a mobile device that allows the associate to engage customers with mobile access to profiles (e.g., personalized information for a customer) and transaction data across different channels (e.g., stores, social networks, or other networks). Using the personalized information, the associate may provide recommendations, place items on hold, checkout the customer, transmit targeted information to the customer via various networks (e.g., social network, e-mail, mobile messaging, direct mailing), provide customized in-store service, and so forth. For example, the associate may send personalized e-mails to the customer regarding a particular item that may be recommended based on past purchases, based on other products that the customer has expressed interest in, or based on social activities (e.g., a friend recently purchasing or watching). The associate may also provide relevant, real-time offers that may be consistent with online offers.

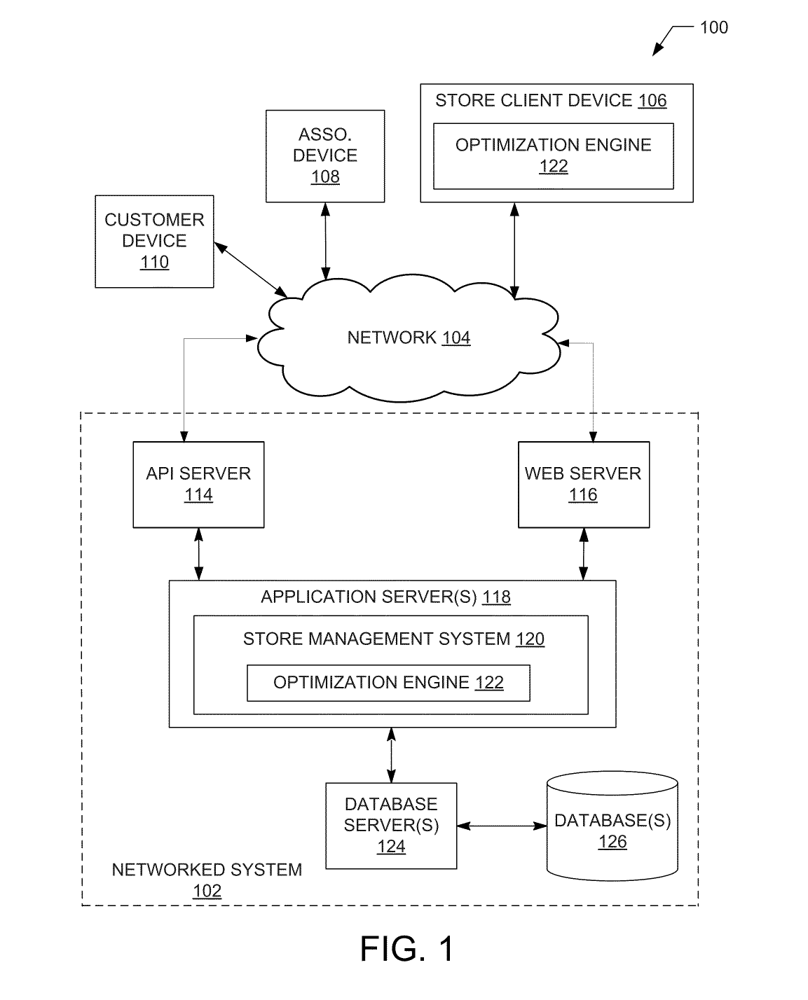

With reference to FIG. 1, an example embodiment of a high-level client-server-based network architecture 100 that enables optimization of in-store customer experience is shown. A networked system 102, in an example form of a network-server-side functionality, is coupled via a communication network 104 (e.g., the Internet, wireless network, cellular network, or a Wide Area Network (WAN)) to one or more store client devices 106. The networked system 102 may also be coupled to one or more associate devices 108 and customer devices 110.

The associate device 108 and customer device 110 may comprise a mobile phone, desktop computer, laptop, or any other communication device that a user (e.g., an associate or a customer of a store) may utilize to access the networked system 102 or the store client device 106. In some embodiments, the associate device 108 and customer device 110 may each comprise a display module to display information (e.g., in the form of user interfaces). In further embodiments, the associate device 108 and customer device 110 may comprise one or more of a touch screen, accelerometer, camera, microphone, and Global Positioning System (GPS) device. The associate device 108 and customer device 110 may be a device of a user, which is used to access content from the networked system 102 or the store client device 106. In one embodiment, the networked system 102 is a network-based marketplace that manages digital goods, publishes publications comprising item listings of products available on the network-based marketplace, and/or manages payments for marketplace transactions.

An Application Program Interface (API) server 114 and a web server 116 are coupled to, and provide programmatic and web interfaces respectively to, one or more application servers 118. The application server 118 hosts a store management system 120 that may comprise an optimization engine 122 that includes one or more modules or applications, and may be embodied as hardware, software, firmware, or any combination thereof. The application server 118 is, in turn, coupled to one or more database servers 124 facilitating access to one or more information storage repositories or database(s) 126. In one embodiment, the databases 126 are storage devices that store digital content for presentation to the associate or customer.

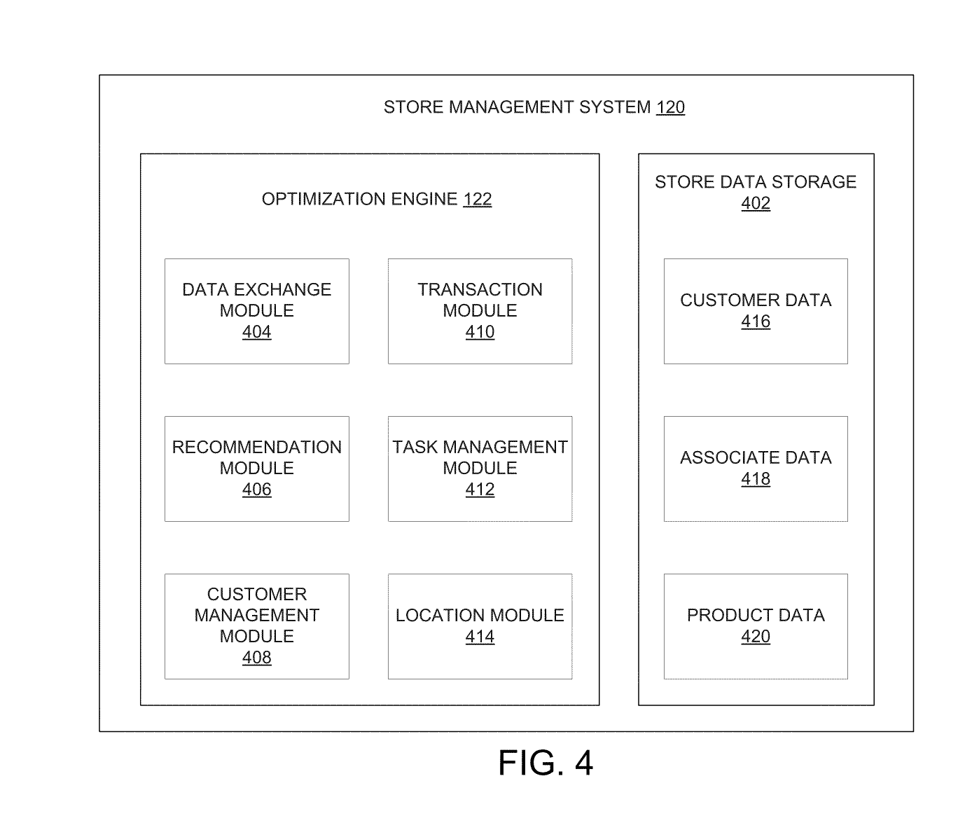

In example embodiments, the store management system 120 enables the optimizing of the in-store customer experience by providing data that is relevant to both the associate and the customer. Such data may include product recommendations, receipts, past purchase information, financial information, trend information, and so forth. The store management system 120 is discussed in more detail in connection with FIG. 4. In example embodiments, the store management system 120 may be an online marketplace environment and/or associated with a non-marketplace environment such as an informational (e.g., search engine) or social networking environment.

In some embodiments, the optimization engine 122 of the store management system 120 may be provided as a software-as-a-service (SaaS) by the networked system 102. As such, a front end application and APIs (application programming interfaces) may be provided to the store client device 106 in the form of a local version of the optimization engine 122. The store client device 106 then ties the optimization engine 122 to their internal data sources. In alternative embodiments, the optimization services may be provided as a platform-as-a-service (PaaS) by the networked system 102. In these embodiments, the data management needed to support the optimization services as well as front end interface is provided to the store client device 106 by the networked system 102. The store client device 106, in turn, may send data to the networked system 102, which hosts and manages all the data.

While the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system.

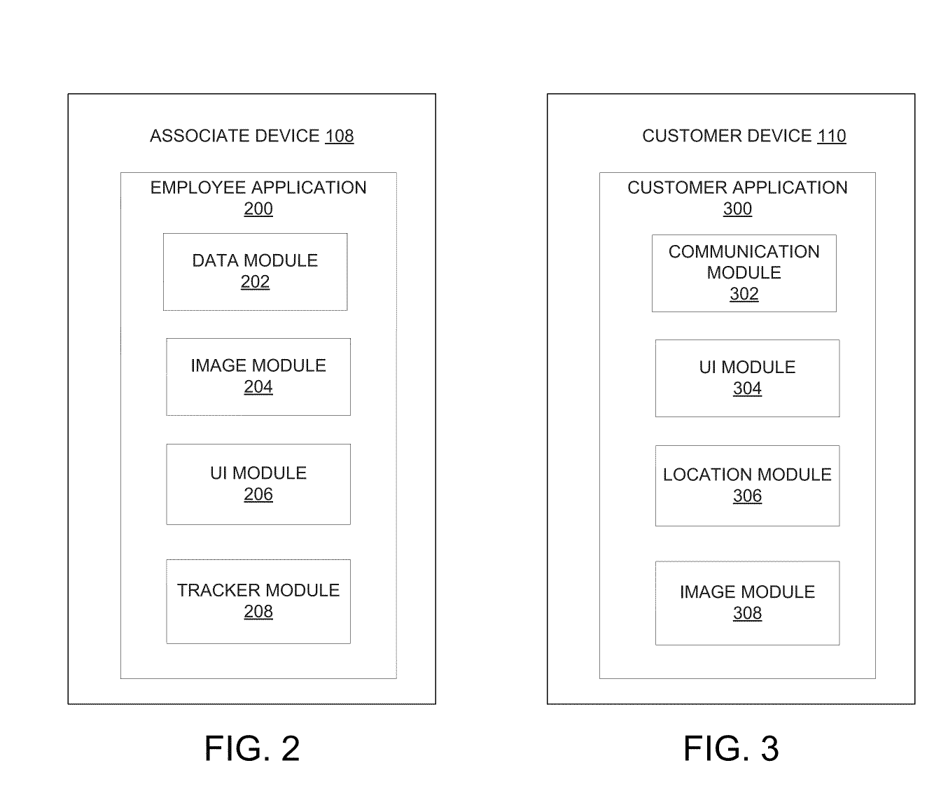

Referring now to FIG. 2, the associate device 108 is shown in more detail. In example embodiments, the associate device 108 is a mobile device such as a tablet. Alternatively, the associate device 108 may be a smartphone, laptop, wearable device, or other handheld computing device. The associate device 108 may exchange information via the network 104 with various systems, components, or servers that provide customized information to the associate device 108. Accordingly, the associate device 108 may comprise an employee application 200 installed, downloaded, or otherwise provided by the store client device 106 or the networked system 102. The employee application 200 allows the associate device 108 to access and present information to the associate that allows the associate to provide an optimized customer experience to the customer. The employee application 200 may comprise a data module 202, an image module 204, a user interface (UI) module 206, and a tracker module 208. It is noted that the associate device 108 may include other modules not directly related to example embodiments of providing an optimized in-store customer experience (not shown or described).

The data module 202 manages data exchange between the associate device 108 and other devices in the network architecture 100 (e.g., the store client device 106 or the networked system 102). For example, the data module 202 may access a customer profile to obtain a customer's previous purchase history from the database 126 (via the store client device 106 or directly through the network 104). The data module 202 may also provide, for example, data to update the customer profile including preferences (e.g., change in size or preferred colors).

The image module 204 may manage images at the associate device 108. In example embodiments, the image module 204 may capture an image of a barcode of a product and use the image to identifier the product or obtain further information regarding the product. In another example, the image module 204 may capture an image of the customer to be included in the customer profile.

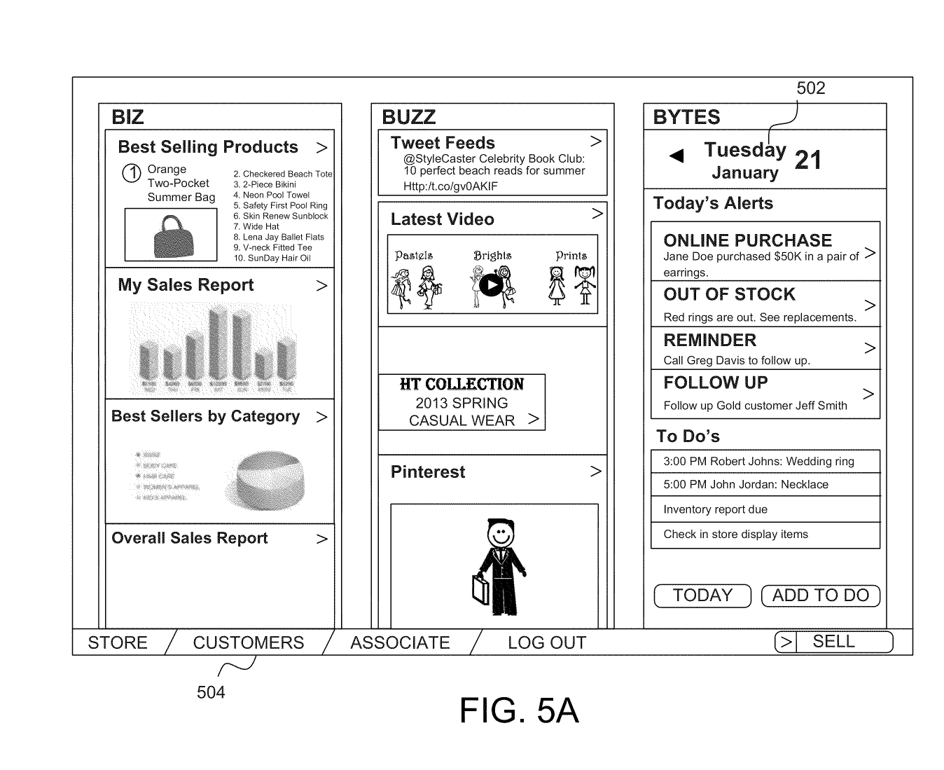

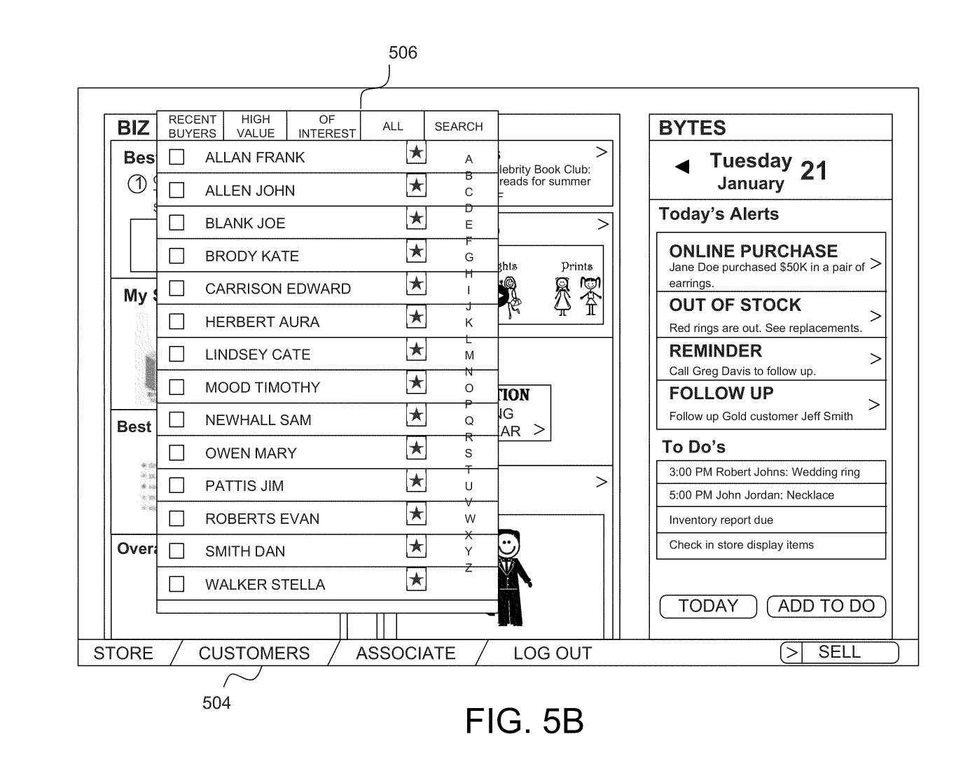

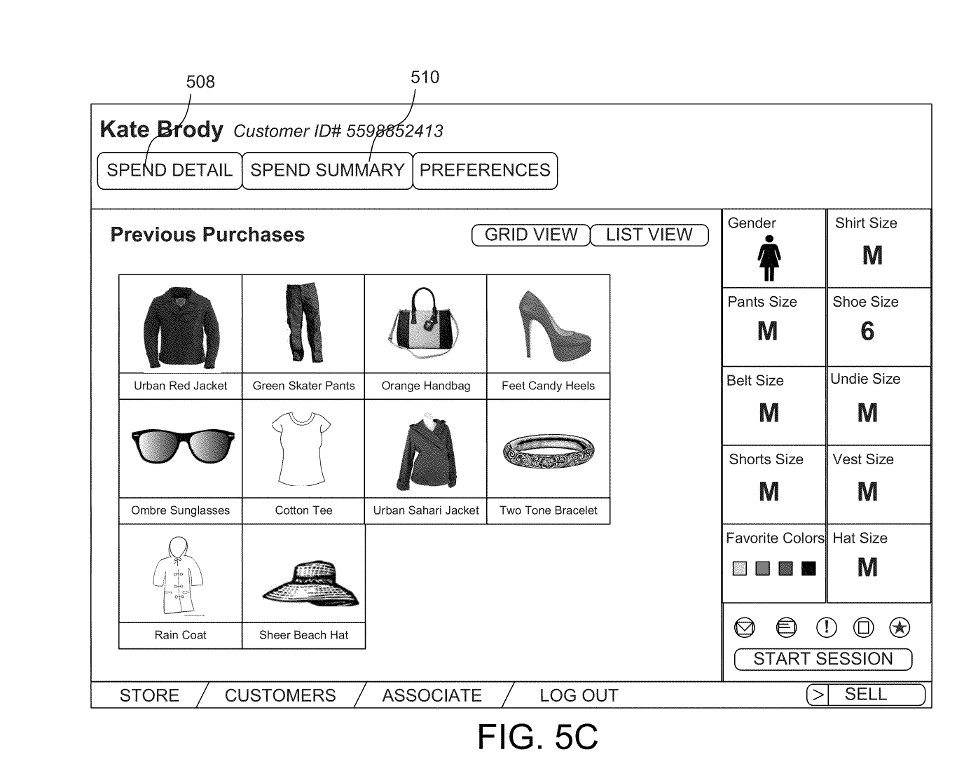

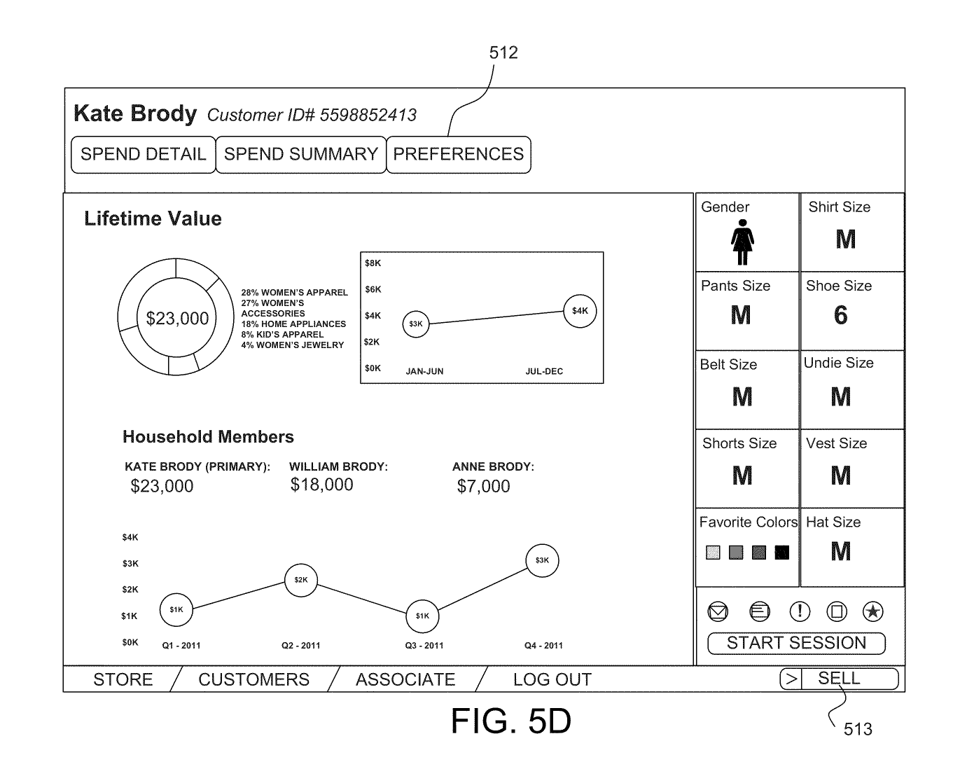

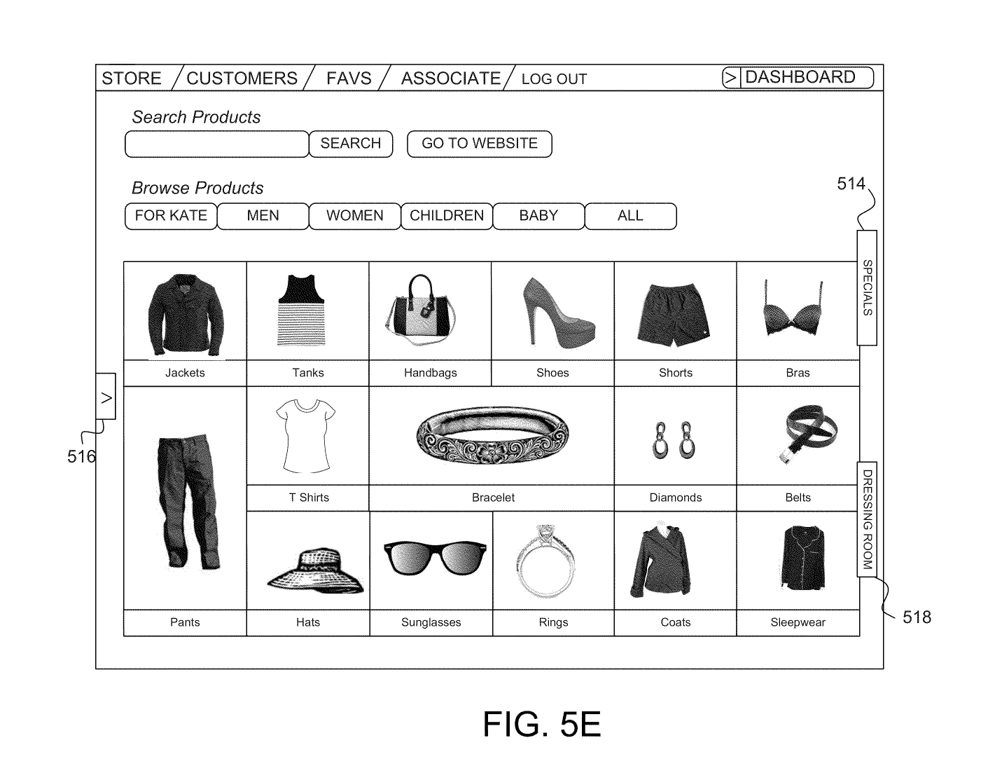

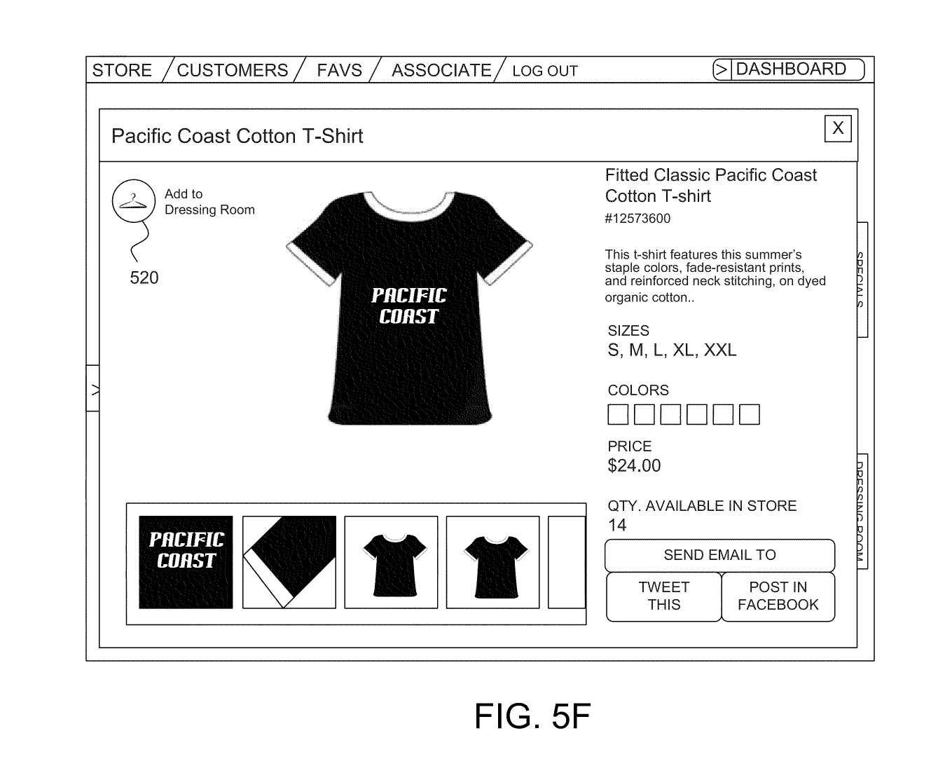

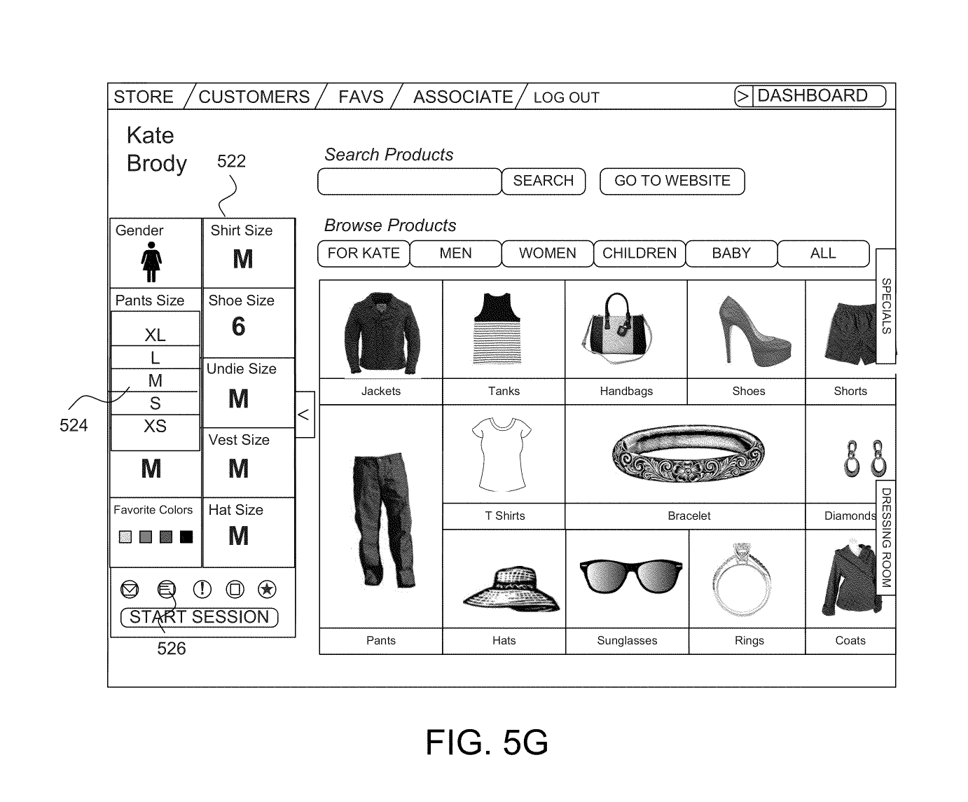

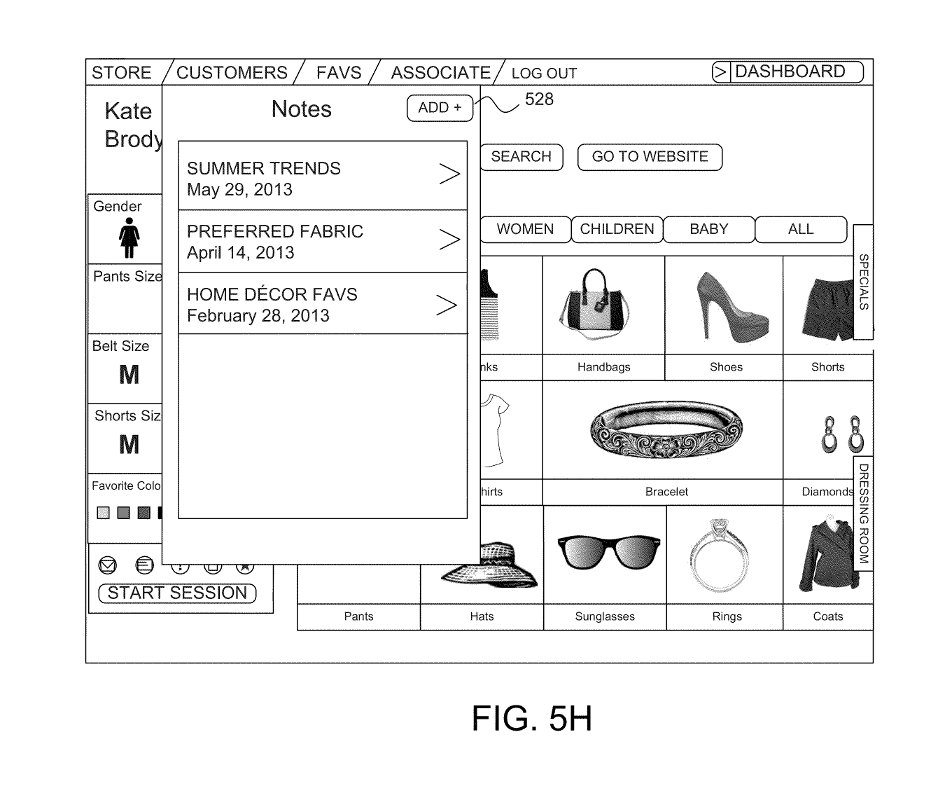

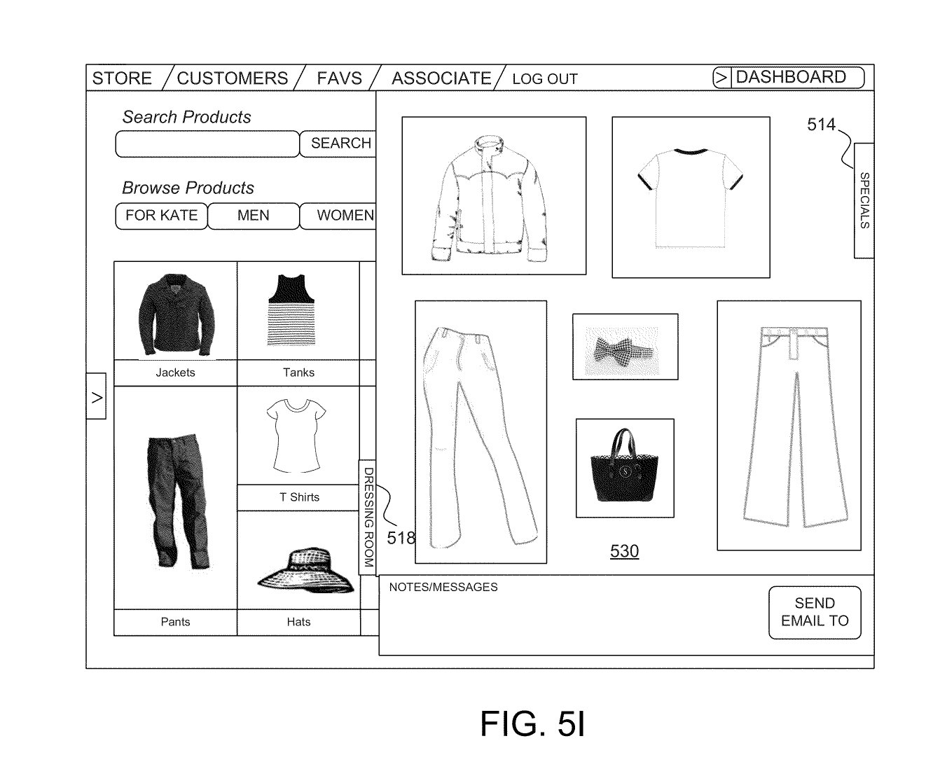

The UI module 206 manages the presentation of user interfaces on the associate device 108. Examples of user interfaces presented on the associate device 108 by the UI module 206 are shown and described in FIG. 5 below.

The tracker module 208 manages location information of the associate device 108. In example embodiments, a location of the associate device 108 in a store may be determined. For example, the tracker module 208 may be linked to a GPS device. In alternative embodiments, other forms of location tracking may be used such as using cameras, beacons, wireless networks, or other sensors located within the store that may exchange location information with the tracker module 208. The location information may then be provided by the tracker module 208 to the store client device 106. The store client device 106 may use the location information to, for example, provide recommendations for products located nearby or to direct the associate to a location for a product a customer may be interested in viewing.

FIG. 3 is a block diagram illustrating an example embodiment of the customer device 110. The customer device 110 may be a mobile device such as a tablet, smartphone, laptop, wearable device, or other handheld computing device of the customer. The customer device 110 may exchange information via the network 104 with various systems, components, or servers that provide personalized information to the customer device 110. Accordingly, the customer device 110 may comprise a customer application 300 installed thereon. The customer application 300 allows the customer device 110 to access and view information customized to the customer. The customer application 300 may comprise a communication module 302, a user interface (UI) module 304, a location module 306, and an image module 308. It is noted that the customer device 110 may include other modules not directly related to example embodiments of providing an optimized customer experience that are not shown or described.

The communication module 302 manages communications and data exchange between the customer device 110 and the store client device 106 or the networked system 102. For example, the communication module 302 may access digital copies of sales receipts from the store client device 106 or the networked system 102.

The UI module 304 manages the presentation of user interfaces on the customer device 110. Examples of user interfaces presented on the customer device 110 by the UI module 304 are described in more detail below.

The location module 306 provides location information of the customer device 110 to the optimization engine 122. In example embodiments, a location of the customer device 110 may be determined. For example, the location module 306 may be linked to a GPS system or other location reference system to obtain its location. The location may then be provided by the location module 306 to the optimization engine 122. The optimization engine 122 may use the location information to, for example, check-in the customer when the customer is within a predetermined distance to the store or in the store.

In some embodiments, the customer device 110 may include an image capture device (e.g., a camera, a scanner) that can capture an image of, for example, a product that the customer is interested in. The image module 308 may provide that image to the optimization engine 122 for matching to known products. For example, the customer may take a picture of a product in a store window. The picture may then be sent to the optimization engine 122 which can match the image to a product.

In some embodiments, the location module 306 may provide location information while the image module 308 provides the image of the product taken in the store window. Using the location information, the optimization engine 122 can determine the store associated with the image (or a store nearby that sells the product in the image) and identify the product as one being available at the store. Product results may be provided to the customer and the customer may select options for the product (e.g., color, size). The product may be put on hold with the store and the customer can come back later in the day to physically see the product.

Refer now to FIG. 4, an example block diagram of the store management system 120 is shown. The store management system 120 enables the optimizing of the in-store (as well as out-of-store) customer experience by providing data that is customized and relevant to both the associate and their customers. To enable this, the store management system 120 may comprises the optimization engine 122 and a store data storage 402. The optimization engine 122 comprises a data exchange module 404, a recommendation module 406, a customer management module 408, a transaction module 410, a task management module 412, and a location module 414. It is noted that the optimization engine 122 may be similar to the optimization engine 122 at the store client device 106 and/or share some functionality. As such, some of the modules or components (or copies) of the optimization engine 122 of the store management system 120 may be located at the optimization engine 122 of the store client device 106, or local versions of the modules of the optimization engine 122 of store management system 120 may be provided at the optimization engine 122 of the store client device 106.

The data exchange module 404 exchanges data with the various components of the network architecture 100. For example, the data exchange module 404 may provide customized information for a particular customer to the associate device 108 directly or through the store client device 106. The data exchange module 404 may also receive information from the various components and update data stored at the store data storage 402 or access information from social networks, gaming networks, or other sources on the Internet. Furthermore, the data exchange module 404 may distribute marketing and training information to the associates. For example, the data exchange module 404 may provide training manuals for brands, videos on brands, and FAQ's (frequently-asked questions) for brands. Additionally, the data exchange module 404 may provide full product catalog access, reporting (e.g., store-based, product, user, comparative, location-based, customizable), planograms, website access, and product lookup (e.g., from product data 420 in the store data storage 402).

The recommendation module 406 provides customized recommendations for the customer based on, for example, stored information for the customer. The stored information may be stored as customer data 416 in the store data storage 402 and may comprise a customer profile. The customer data 416 may also include store data, social network/media data, gaming network data, kiosk data, online shopping data, mobile device data, offline transaction data, offline marketing data, email data, online transaction data, online marketing data, and preference data corresponding to the customer. The customer profile may include preference and sizing information for the customer as well as past purchases, financial information, and social network information. Accordingly, the recommendation module 406 may perform dynamic offer generation (e.g., custom offers, profile-based offers, past purchase-based offers, real-time offers). In some cases, the recommendation module 406 may provide a guide to the associate for selling a product to a customer. Additionally, the recommendation module 406 may provide an ability to match products in a catalog (e.g., product data 420) using an image provided by the image module 204 or the image module 308. In some embodiments, the recommendation module 406 may also perform social listening (e.g., detecting social media trends in substantially real-time) by accessing social networks and social websites.

The customer management module 408 manages customer profiles. In example embodiments, the customer management module 408 may update the customer data 416 stored at the store data storage 402. For example, if the customer indicates a change in size or color preference, the customer management module 408 updates the corresponding customer profile. When the customer makes a purchase, the customer management module 408 may associate products purchased by the customer with the customer profile.

The transaction module 410 manages transactions involving products. When a purchase is made, the transaction module 410 may track orders (e.g., track shipping, track returns) from a store, website, warehouse, or product catalog. The transaction module 410 may also audit inventory, and indicate when inventory needs to be replenished. Furthermore, the transaction module 410 may perform checkout processing (e.g., purchase and payment for products).

The task management module 412 manages tasks of the associate. In example embodiments, the task management module 412 may access associate data 418 in the store data storage 402 and use the associate data 418 to provide task management. For example, the task management module 412 may remind the associate to call a customer at a particular time, remind the associate to ship an item, and inform the associate to place an item on hold. The task management module 412 may also provide calendar information and reminders to the associate.

The location module 414 provides location services. For example, location-based offers may be delivered to the customer or the associate at their respective devices. The location module 414 may also provide content based on the location of the associate device 108 within the store. For example, if the associate is in a particular area of the store in which a recommended product is located, the location module 414 (e.g., via the recommendation module 406) may provide a notice to the associate to recommend and/or show the product to the customer.

While the store data storage 402 is shown as being within the store management system 120, in some embodiments, the store data storage 402 may be located at the databases 126 of the networked system 102. Further still, some of the data stored in the store data storage 402 may be located within or associated with the store client device 106.

FIG. 5A is an example screenshot of a user interface presenting an associate dashboard. The information presented on the associate device 108 may be received by the data module 202 and presented by the UI module 206. In example embodiments, the sales associate initially logs in on their associate device 108. The sales associate may then check their “dashboard,” which provides business intelligence (e.g., best selling products, sales reports), social listening (e.g., access tweet feeds, Facebook posts, Pinterest posts), calendaring, to-do lists, and alerts (e.g., reminders, follow ups) to the associate. The data provided on the user interface may be received from the data exchange module 404 of the optimization engine 122.

Each column of the dashboard (e.g., BIZ, BUZZ, and BYTES) is scrollable with up and down finger gestures. The BIZ column may provide, for example, a best selling products report, a sales report, a best selling category report, and an overall sales report. The information found in the various reports may be obtained from the store data storage 402 via the data exchange module 404.

If the associate selects to review the best selling products report (e.g., by tapping on the title), a display of the store's best selling products may be presented. The display may include charts indicating the number of the products sold over a particular period of time whereby the period of time is selectable by the associate. The associate may also select to compare her store's best sellers to another store's best sellers (within a chain of stores). Accordingly, charts may be updated to show a comparison of, for example, the number of the best selling products sold at both stores.

In some cases, the associate may select to review social network postings regarding trends and the store from the BUZZ column. For example, the associate may select to view a new trend video (“Latest Video”) posted on a social network site. While watching the video, the associate may decide to send a link to the video to one of her loyal customers. The associate may use a notes field to write a note to the customer and perform a customer lookup.

A selection of a customer lookup selector may cause a popup interface providing a customer contact list. The associate may select one of the customers from the contact list to send the note. Alternatively, the sales associate may review other information on the dashboard and decide to send an e-mail to a particular customer by performing the same customer look-up (e.g., contacts) and invite the customer to visit the store.

The sales associate can add an appointment with the customer to their calendar via the same dashboard by selecting a calendar trigger 502. The calendar trigger 502 may cause, for example, a month calendar popup to be displayed from which the associate may select a date for the appointment.

The BYTES column also presents alerts and a to-do list customized to the associate. The alerts may include, for example, customer purchases (e.g., online or in store), products that are out of stock, reminders, and follow ups. The to-do list may indicate appointments or events that are calendared to be performed by the associate. The data for the to-do list (e.g., associate data 418) may be obtained from the store data storage 402. For example, the associate may have scheduled appointments later in the day or have deadlines for work that are due (e.g., inventory report).

Prior to an appointment with a customer, the associate may decide to access the customer profile for the customer and review the customer's previous purchases to prepare for the appointment. Accordingly, the associate may select a “customers” tab 504 to bring up a list of customer contacts in a popup interface 506 (shown in FIG. 5B) from which the customer may be selected to view a profile of the customer. For example, the associate may select “Kate Brody.”

Based on the selection of the customer, the customer profile is accessed from the store data storage 402 (e.g., the customer data 416) and presented to the associate. FIG. 5C is an example screenshot of the user interface presenting purchase history and profile information for the customer (e.g., based on a selection of a “spend detail” tab 508). The past purchases may be graphically presented on the user interface. Alternatively, the past purchases may be presented in a list view. Selection of a product that is a past purchase may bring up more details about the product (e.g., product data 420 from the store data storage 402). The profile information for the user may include, for example, sizing information (e.g., shirt size, pant size, shoe size) and preferences (e.g., favorite colors).

In one scenario, the associate may review a spending summary of the customer by selecting a “spend summary” tab 510. FIG. 5D is an example screenshot of the user interface presenting a spending summary for the customer. The spending summary may provide the associate with a detailed financial report for the customer and their household members based on customer data 416 associated with their customer profile.

The associate may further select a “preference” tab 512 that may provide a user interface indicating communication preferences. For example, the user interface may indicate if the customer is opted in for receiving emails, phone calls, or a catalog. Address and phone number information as well as a loyalty membership number and household members list may be included in the preference user interface. In some embodiments, the preference user interface may also indicate stores (e.g., on a map) within the same chain where the customer has shopped.

The associate may then switch the employee application 200 to a sell mode when, for example, customers start coming into the store. Accordingly, the sales associate may trigger a sell mode slider 513 on the associate device 108 to switch to a sell mode view that provides both active and previous customer sessions. A customer session may include recommendations for products that a customer may be interested in. The customer session may also allow the sales associate to quickly access the customer profile and make any necessary changes (e.g., size). The user interface may present a list of customer sessions graphically from which the associate selects.

In some embodiments, when a customer arrives at the store, the customer may check-in. That is, for example, the user may indicate on their customer device 110 (e.g., smartphone) their presence at the store, or the location module 306 of the customer device 110 may provide automatic notification of the customer's presence to the store client device 106 or the networked system 102. Information regarding the customer may be transferred to the associate device 108 of the associate. The information may include a photo of the customer along with a name. As a result, the associate may identify and greet the customer and initiate a sales “concierge” service for the customer.

Referring now to FIG. 5E, a sell interface personalized to customer Kate Brody is presented on the associate device 108. The sell interface is provided in response to the associate selecting and activating a current session for the customer Kate Brody. The sell interface provides various categories that the customer may be interested in browsing or searching through. The sell interface also provides quick access to specials using a specials slider 514 (or other mechanism that causes a display of specials), the customer profile using a profile slider 516 (or other mechanism that causes a display of the customer profile information), and a virtual dressing room of the customer using a dressing room slider 518 (or other mechanism that causes a display of a virtual dressing room. The virtual dressing room may be presented as a slide interface, pop-up interface, or other type of interface that provides a location where selected products may be virtually held for later review as will be discussed in more detail below.

The associate may search for products with the customer, and product results may be provided by the recommendation module 406. For example, the customer may search for t-shirts and arrive at the user interface shown in FIG. 5F. The associate may pull up product options for the t-shirt such as size and color as well as product details. Various views of the product (including close up views) and views of the product in different colors may be shown. Additionally, the associate may send an email or provide details of the product to one or more social networking sites or individuals. In example embodiments, the product may be added to the customer's virtual dressing room for later review and checkout by selecting an add button 520.

Returning to FIG. 5E, the customer may indicate that their size has changed. In one embodiment, the associate may activate the profile slider 516 by swiping it in a direction of the arrow. As a result, a profile interface 522 is presented as shown in FIG. 5G. The profile interface 522 may be a slide out overlay that shows the profile information (e.g., sizes and preferences) of the customer. In other embodiments, the profile interface may comprise other types of display interfaces (e.g., pop-up, feature pane). In the present example, the customer's pant size has changed. As such, the associate may tap on “pant size” and a size popup 524 is presented from which the associate can indicate the new size. The new size may then be saved as customer data 416 in the store data storage 402 by the customer management module 408.

The associate may also access previous notes or add new notes to the customer profile. For example, the associate may select a note button 526 on the profile interface 522. The selection may cause a notes screen to be displayed as shown in FIG. 5H with note data provided by the data exchange module 404. The associate may add a new note by selecting an add button 528 or access a previous note (which may be written by any associate) by selecting the previous note from the note screen. Previous notes may also be edited and saved back in the user profile. The profile interface 522 may be closed using the profile slider 516 (e.g., sliding the profile slider 516 closed).

All products tagged by the customer in the session are saved to a virtual dressing room, which can be accessed via, for example, the dressing room slider 518. The virtual dressing room may be managed by the recommendation module 406. FIG. 5I illustrates one example of a dressing room interface 530 (presenting content within the virtual dressing room) after the dressing room slider 518 is swiped to the left to access the dressing room interface 530. In the present embodiment, the dressing room interface 530 is presented as a slide out overlay over a main user interface and shows the products from the current session that the customer and associate have marked as being of interest. In other embodiments, the profile interface may comprise other types of display interfaces (e.g., pop-up, feature pane). The associate (or customer) may drag products around in the dressing room interface 530, for example, to create different combinations of looks for the customer (e.g., lining up a jacket or shirt over a pair of pants and next to a handbag). In one embodiment, these products may also be overlaid on an image of the customer to display how the products would look on them.

In example embodiments, the store's specials may be viewed by swiping the specials slider 514 open. In response, an interface of special deals from the store may be shown to the customer. The specials may be accessed at any time prior to checkout.

Products in the virtual “dressing room” may then be paid for via a checkout process. In one embodiment, the customer may go to a physical checkout counter to perform a transaction to purchase the products in the dressing room. In other embodiments, the customer can pay for their purchases (e.g., products in their virtual dressing room) via the associate device 108. The customer can pay via PayPal®, using a credit card (with swipe ability on the mobile device), using installments, a tab, or other payment methods.

As the customer leaves the store, the customer may receive a purchase notification from a payment service provider associated with the network system 102 on their customer device 110. The notification may indicate items purchases, prices, sales tax, and total amount spent. The notification may also include a loyalty rewards total.

In some embodiments, the customer does not need to make a payment at the sales counter. Instead, the customer may be given a grace period to pay, and an indication of the grace period may be presented to the customer in the notification. For example, the customer may be given seven days to decide how to pay for a purchase. Alternatively, other payment options may be presented. For instance, the customer may have her store credit card assigned as a default payment method for the store purchases. However, the customer has an option to use a different payment method (e.g., a different credit card, PayPal®). The customer may also have an option to make installment payments. All of these options may be presented in a notification sent (e.g., by the transaction module 410) to the customer device 110.

Instead of having to save and maintain paper receipts, the payment service provider or the networked system 102 may store digital copies of the receipts. The customer may access, view, and sort (e.g., by date or merchant) the receipts.

In some embodiments, the customer application 300 may use information and functionalities of the optimization engine 1252, as well as the location module 306, to cause the user interface to present a map that indicates nearby places that the customer has shopped at.

As such, example embodiments allow the associate to be customer-focused. In one scenario, the associate at a sales counter can quickly see all customers that have checked-in, how long they have been at the store, and whether they are already being helped by another associate. By tapping on any customer session (e.g., tapping on an image of the customer), the associate can bring up customized information for the customer. For example, the associate can pull up a particular customer profile and greet the customer by name when she gets to the sales counter. The associate can then chat with the customer about a product that the customer has on hold or a product that the customer had previously purchased as well as provide product recommendations to the customer.

In some embodiments, the associate may pick out products to recommend to the customer based on the customer's shopping history and preferences. Alternatively, a component of the recommendation module 406 may provide suggestions on recommended products based on the customer profile. The associate may then present the recommended products using the associate device 108.

The accompanying figures provide screenshots of example user interfaces that illustrate some of the functions that are performable on the associate device 108. The example user interfaces are provided by way of illustration and the functions are not limited to those shown.

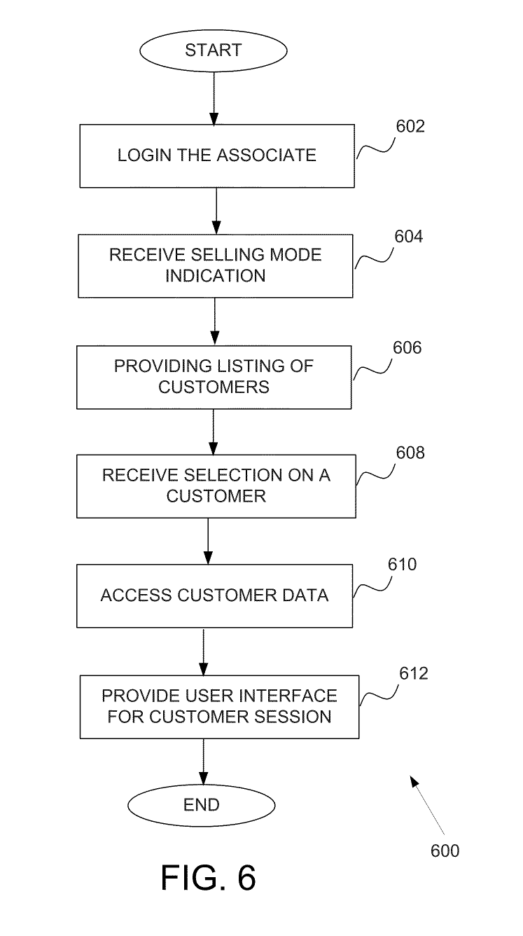

Referring now to FIG. 6, a flowchart of an example method 600 for activating a customer session is shown. The operations of the method 600 may be performed by the optimization engine 122 (e.g., the data exchange module 404) in response to actions performed by the associate on their associate device 108. In operation 602, the associate logs into the system. In example embodiments, the associate may provide an identifier and a password, which may be authenticated by the data exchange module 404 of the optimization engine 122.

Once logged in, the associate may be presented an option to access different modes or views provided by the optimization engine 122. The options may include a dashboard mode, a selling mode, and a training mode. In one embodiment, the associate may select the selling mode. Accordingly, a selling mode indication is received in operation 604 (e.g., by the data exchange module 404).

In response, a listing of customers may be provided for presentation to the associate in operation 606. The listing of customers may be organized into a current session, previous session, and most recent sessions and be graphically displayed on the associate device 108. In some cases, the listing may include a photo of each of the customers associated with a session. In one example, the data exchange module 404 may access the customer data 416 to determine the listing of customers and corresponding organization of the customers into the various session types.

In operation 608, selection of a customer from the listing is received by the data exchange module 404. For example, the associate may tap on a photo of a customer with whom the associate would like to start a new customer session. The selection of the customer triggers access of the corresponding customer data 416 (e.g., customer profile) by the data exchange module 404.

In operation 612, a user interface is caused to be presented on the associate device 108. The user interface may present at least some of the accessed customer data or provide access to the customer data.

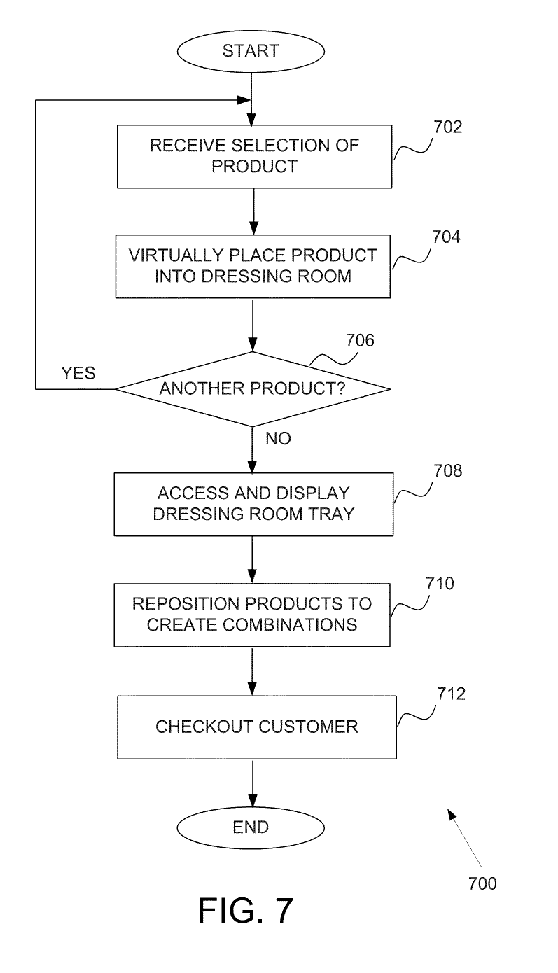

FIG. 7 is a flowchart of an example method 700 for interacting with a virtual dressing room. The method may be performed by components of the data module 202 and UI module 206 of the employee application 200 in conjunction with data provided by the data exchange module 404 of the optimization engine 122. During a customer session (e.g., initiated by the method 600 of FIG. 6), the associate may review and select products while interacting with the customer and save the products to a virtual dressing room for later access. Accordingly, in operation 702, a selection of a product is received. For example, the associate and the customer may browse or search through a collection of products, access details for a particular product, and then indicate to save the product to the virtual dressing room. Based on the indication, the product is placed into the virtual dressing room (e.g., dressing room interface) in operation 704.

In operation 706, a determination is made as to whether further products are desired. For example, the associate and customer may return to browsing or searching for products. If no further products are desired, then the dressing room interface may be accessed and displayed in operation 708. For example, the associate may activate a dressing room slider 518. Accordingly, products that were marked to be sent to the virtual dressing room may be displayed on the user interface.

In operation 710, the images of the products may be repositioned on the user interface in order to allow the associate and customer to create product combinations. For example, the associate may drag images around to position different products into visual combinations to view compatibility. Products may be deleted that the customer is no longer interested in, and new products (e.g., specials) may be added.

Subsequently, in operation 712, the customer can checkout with the products that they decide to keep. In some embodiments, the customer can be checked out directly on the associate device 108. In other embodiments, the associate device 108 may communicate the final contents of the dressing room interface to the transaction module 410 of the optimization engine 122. The customer may then go to a sales counter to pay for the products, whereby a device at the sales counter can access the transaction module 410 to determine the products being purchased. Alternatively, the customer may pay using their customer device 110. Further still, the customer may just take their purchases and be given a grace period to pay for the products.

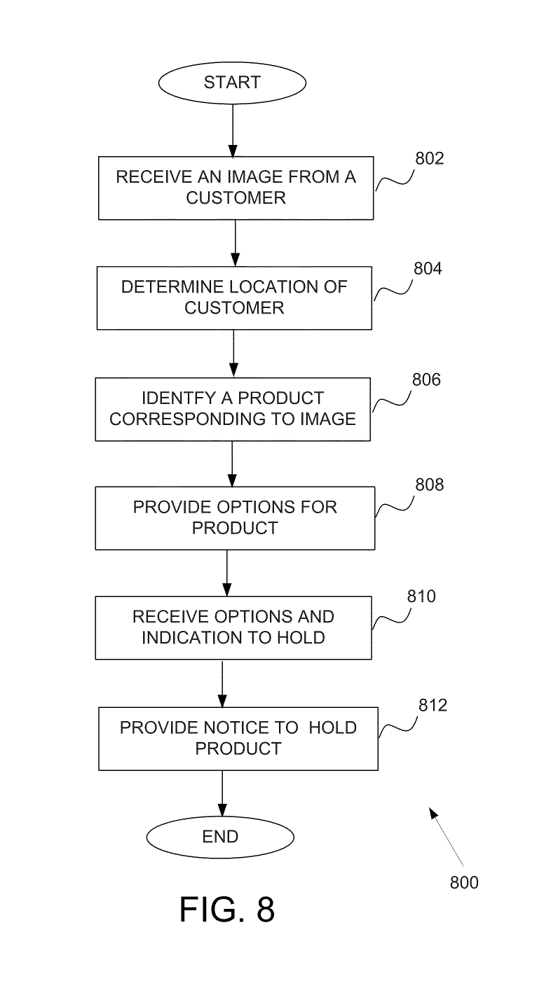

FIG. 8 is a flowchart of an example method 800 for managing a customer hold process. In operation 802, an image is received from the customer device 110. For example, the customer may take a photo of a product or scan a barcode of a product using the image module 308 of their customer device 110. The customer then sends the image to the optimization engine 122.

In some embodiments, a location of the customer (e.g., their customer device 110) is determined in operation 804. Accordingly, the location module 306 may determine the location of the customer device 110 and send the location information to the optimization engine 122. The location information may be used to determine what store the customer may be located near that may carry the product in the image. Operation 804 may be optional in some embodiments.

In operation 806, the product corresponding to the received image is determined. In example embodiments, the recommendation module 406 may take the image and perform a lookup or matching process with product data 420 in a store data storage 402.

Once the product is identified, options for the product may be provided to the customer device 110 in operation 808. For example, the recommendation module 406 may provide details of the identified product along with color, size, and quantity options.

In operation 810, an indication to hold the product is received. The indication may be received along with any options that are selected by the customer. In example embodiments, a notice to hold the product may be provided to one or more associates in operation 812.

### Modules, Components, and Logic

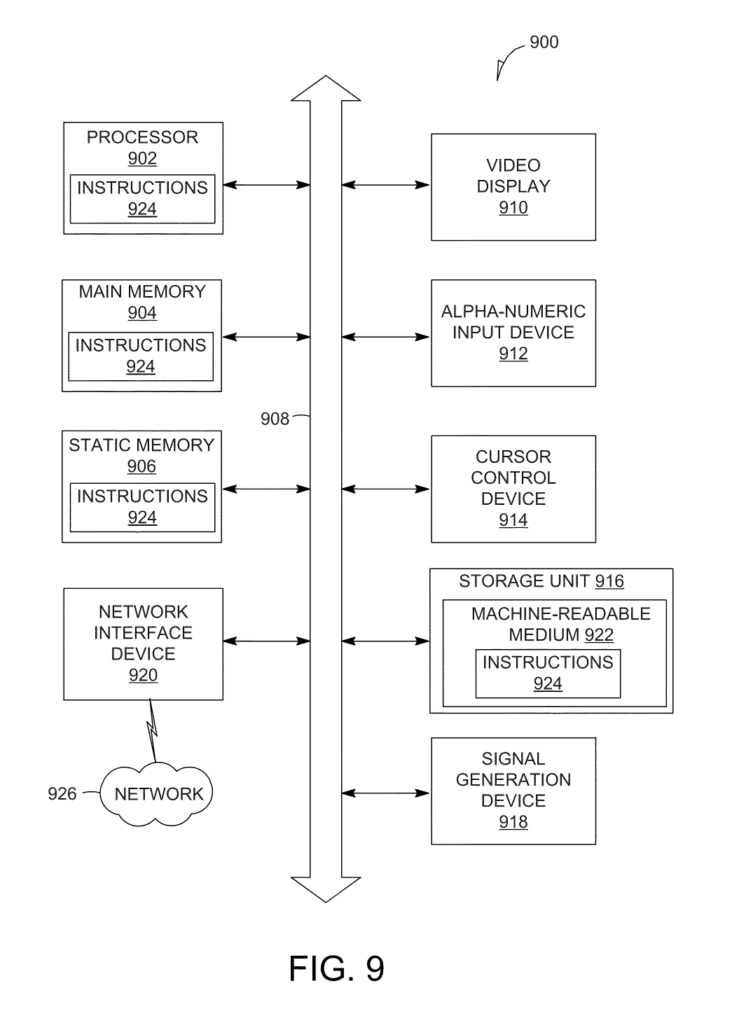

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system and within which instructions 924 (e.g., software, a program, an application, an applet, an app, or other executable code) for causing the machine 900 to perform any one or more of the methodologies discussed herein may be executed. In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application-specific integrated circuit (ASIC), a radio-frequency integrated circuit (RFIC), or any suitable combination thereof), a main memory 904, and a static memory 906, which are configured to communicate with each other via a bus 908. The machine 900 may further include a graphics display 910 (e.g., a plasma display panel (PDP), a light emitting diode (LED) display, a liquid crystal display (LCD), a projector, or a cathode ray tube (CRT)). The machine 900 may also include an alpha-numeric input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a speaker), and a network interface device 920.

The storage unit 916 includes a machine-readable medium 922 on which is stored the instructions 924 embodying any one or more of the methodologies or functions described herein. The instructions 924 may also reside, completely or at least partially, within the main memory 904, within the processor 902 (e.g., within the processor's cache memory), or both, during execution thereof by the machine 900. Accordingly, the main memory 904 and the processor 902 may be considered as machine-readable media. The instructions 924 may be transmitted or received over a network 926 via the network interface device 920.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 900), such that the instructions, when executed by one or more processors of the machine (e.g., processor 902), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 924 may further be transmitted or received over a communications network 926 using a transmission medium via the network interface device 920 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A non-transitory machine-readable storage medium in communication with at least one processor, the machine-readable storage medium storing instructions which, when executed by the at least one processor, cause the machine to perform operations comprising:
providing, to a mobile device of a user, a list of a plurality of customers from which a selection is made to initiate a customer session;
receiving a selection of a customer from the list of the plurality of customers, the selection initiating the customer session for the selected customer;
accessing customer data of the selected customer, the customer data including a customer profile of the customer that includes sizing and preference information for the customer; and
causing the mobile device to present a user interface for the customer session that presents products for customer review and access to the customer data.

2. The non-transitory machine-readable storage medium of claim 1, wherein the list of the plurality of customers comprises a listing of customers that are checked into a location associated with the mobile device.

3. The non-transitory machine-readable storage medium of claim 1, wherein the operations further comprise:
receiving an indication to access a profile interface on the user interface;
in response to an attribute change indication, updating an attribute displayed in the profile interface; and
storing the updated attribute to the customer profile of the customer at a data storage.

4. The non-transitory machine-readable storage medium of claim 1, wherein the operations further comprise:
receiving an indication to access specials offered by a store; and
providing the specials for display on the user interface.

5. The non-transitory machine-readable storage medium of claim 1, wherein the operations further comprise:
receiving a selection of a product during the customer session; and
placing the selected product in a virtual dressing room.

6. The non-transitory machine-readable storage medium of claim 5, wherein the operations further comprise:
providing a dressing room interface to view products that have been placed into the virtual dressing room; and
allowing the user to rearrange images of the products on the dressing room interface to view different product combinations.

7. The non-transitory machine-readable storage medium of claim 1, wherein the operations further comprises:
receiving an indication to view a spending summary of the customer; and
causing a spend interface to be presented showing the spending summary, the spending summary including an amount spent over a predetermined amount of time.

8. The non-transitory machine-readable storage medium of claim 1, wherein the operations further comprise:
receiving an indication to view notes corresponding to the customer; and
causing a notes interface to be presented showing a note previously stored for the customer.

9. The non-transitory machine-readable storage medium of claim 1, wherein the operations further comprise:
receiving an indication to create a note for the customer;
providing an interface that receives text for the note; and
storing the note to the customer profile at a data storage.

10. The non-transitory machine-readable storage medium of claim 1, wherein the operations further comprise:
performing a checkout process for the customer;
providing a notification to a device of the customer describing products and costs involved in the checkout process; and
providing an option to select a payment method.

11. The non-transitory machine-readable storage medium of claim 1, wherein the operations further comprise:
receiving an indication to provide a communication to the customer;
providing a customer list from which to select the customer to send the communication; and
in response to a selection of the customer from the customer list, sending the communication to the customer.

12. The non-transitory machine-readable storage medium of claim 1, wherein the operations further comprise:
receiving an image of a product from a device of a customer;
determining the product corresponding to the image;
providing product information for the product to the customer;
receiving an indication to hold the product for the customer; and
providing an indication to the user to hold the product for the customer.

13. The non-transitory machine-readable storage medium of claim 1, wherein the user is different from the customer.

14. A system comprising:
a hardware processor; and
a data exchange module to:
provide, to a mobile device of a user, a list of a plurality of customers from which a selection is made to initiate a customer session,
receive a selection of a customer from the list of the plurality of customers, the selection initiating the customer session for the selected customer,
access customer data of the selected customer, the customer data including a customer profile of the customer that includes sizing and preference information for the customer, and
cause the mobile device to present a user interface for the customer session that presents products for customer review and access to the customer data.

15. The system of claim 14, further comprising a customer management module to, in response to an attribute change indication, update an attribute of the customer stored in the customer profile of the customer at a data storage.

16. The system of claim 14, further comprising a transaction module to:
perform a checkout process for the customer;
provide a notification to a device of the customer describing products and costs involved in the checkout process; and
provide an option to select a payment method.

17. The system of claim 14, further comprising:
a recommendation module to receive an image of a product from a device of a customer, determine the product corresponding to the image, provide product information for the product to the customer, and receive an indication to hold the product for the customer; and
a task management module to provide an indication to the user to hold the product for the customer.

18. A method comprising:
providing, to a mobile device of a user, a list of a plurality of customers from which a selection is made to initiate a customer session;
receiving a selection of a customer from the list of the plurality of customers, the selection initiating the customer session for the selected customer;
accessing customer data of the selected customer, the customer data including a customer profile of the customer that includes sizing and preference information for the customer; and
causing, using a hardware processor, the mobile device to present a user interface for the customer session that presents products for customer review and access to the customer data.

19. The method of claim 18, further comprising:
receiving a selection of a product during the customer session;
placing the selected product in a virtual dressing room;
providing a dressing room interface to display products that have been placed in the virtual dressing room; and
allowing the user to rearrange images of the products on the dressing room interface to view different product combinations.

20. The method of claim 18, further comprising:
receiving an image of a product from a device of a customer;
determining the product corresponding to the image;
providing product information for the product to the customer;
receiving an indication to hold the product for the customer; and
providing an indication to the user to hold the product for the customer.
